(19) United States
(12) Patent Application Publication
(10) Pub. No.: US 2026/0169868 A1
(43) Pub. Date: Jun. 18, 2026

(54) SmartNIC-Based Immutable Backup, Recovery, and Threat Detection System for Operational Technology (OT) and Industrial Control Systems (ICS) Environments

(71) Applicant: Salvador Technologies Ltd, Rehovot (IL)

(72) Inventors: Oleg Vusiker, Petach Tikva (IL); Alex Yevtushenko, Kiryat Gat (IL); Amit Hammer, Herzliya (IL)

(21) Appl. No.: 19/419,127

(22) Filed: Dec. 15, 2025

Related U.S. Application Data
(60) Provisional application No. 63/735,330, filed on Dec. 18, 2024.

(51) Int. Cl. G06F 11/1446; G06F 21/60

(52) U.S. Cl. CPC G06F 11/1469; G06F 21/602; G06F 2201/84

(57) ABSTRACT

This invention relates to SmartNIC-based cyber recovery for OT/ICS environments. In a centralized mode, a SmartNIC is disposed in-line between an OT/ICS network and external storage, intercepting and processing backup traffic in an isolated runtime environment. In an edge mode, the SmartNIC is coupled to local storage and presents an immutable SNAP (storage-defined network accelerated processing) snapshot as a bootable drive, enabling server recovery within a short time interval, while internal storage is rebuilt in the background. The system generates immutable, cyberattack-resistant backups using a SmartNIC-based immutable snapshot algorithm and a hidden partitions algorithm that keeps backup data inaccessible during normal operation. Snapshot analytics on the SmartNIC detect OT/ICS-specific anomalies and malware and identify clean recovery points. Critical operations, including cryptographic key handling, access control, and snapshot generation, are confined to the isolated SmartNIC environment to enhance resilience and reliability.

### BACKGROUND OF THE INVENTION

### Field of the Invention

The present invention relates to the field of cybersecurity, data recovery, and storage management systems. More particularly, this invention encompasses a SmartNIC-based (Smart Network Interface Card) resilient cyber recovery system designed to enhance data protection, access control, and threat detection in OT/ICS (Operational Technology/Industrial Control Systems) environments.

### Background Art

In some OT/ICS environments, backup and disaster recovery solutions rely on centralized backup servers that share the same trust domain, credentials, and attack surface as the protected hosts. When an attacker compromises an endpoint, gains elevated privileges, or abuses a management console, backup agents and backup storage may be disabled, modified, deleted, or used as additional points of compromise.

Even when backup data is successfully created, backup images may be generated and stored without strong isolation from the production environment and without sufficiently deep security inspection. As a result, backups can silently contain undetected malware, dormant “time bomb” payloads, backdoors, or corrupted configuration data. When such a backup is later used for restoration, there is a risk that the malware or misconfiguration is reintroduced into a system that is believed to be in a clean state. In OT/ICS networks, restoring from a compromised backup can also lead to renewed lateral spread of malware into devices that were previously rebuilt or restored, undermining incident-response and recovery efforts.

In addition, certain approaches do not provide hardware-enforced immutability at the storage layer or an isolated computing environment dedicated to analyzing backup content. Backup volumes can, in certain configurations, be modified or deleted using credentials that an attacker has already obtained, and security tools running on production servers consume CPU and memory resources and may themselves be exposed to termination or tampering. Accordingly, there is a need for a cyber recovery approach that isolates backup generation, storage, and analytics from the host environment, enforces immutability and controlled access at the storage layer, and evaluates backups for indicators of compromise before they are used for recovery, thereby reducing the risk that restoration operations reintroduce malware, latent time bombs, or other persistent threats into OT environments.

### BRIEF SUMMARY OF THE INVENTION

The present invention provides a SmartNIC-based resilient cyber recovery system for OT/ICS environments. Critical backup, recovery, and security functions are moved into an isolated runtime environment on a SmartNIC positioned at the storage layer, enabling the SmartNIC to terminate storage traffic, generate and manage immutable backup snapshots, and control access to backup data independently of host systems and domain administrators.

In some embodiments, the system operates in an Edge Mode in which the SmartNIC is coupled to dedicated local storage and presents an immutable snapshot as a bootable drive, enabling rapid recovery while internal storage is rebuilt in the background. In other embodiments, the system operates in a Centralized Mode in which the SmartNIC is disposed in-line between an OT/ICS network and external storage and exposes logical backup volumes or virtual disk images stored on the external storage as bootable recovery targets.

The system further employs a SmartNIC-based immutable snapshot algorithm, a hidden partitions algorithm, and pre-recovery snapshot analytics. Backup data is stored in immutable or hidden locations that are only manageable through an Out-of-Band (OOB) interface, and snapshots can be scanned in the isolated SmartNIC environment for indicators of compromise. This reduces the risk that recovery operations will reintroduce malware, dormant “time bombs,” or other latent threats from infected backups into systems believed to be in a clean state.

### BRIEF DESCRIPTION OF THE FIGURES

FIG. 1 illustrates a centralized configuration of the system in which a SmartNIC operating in a PCIe-isolated mode is positioned in-line between the organization LAN and centralized external storage, with administrative access provided solely through a VLAN-segmented or air-gapped Out-of-Band (OOB) management port.

FIG. 2 depicts an edge-mode configuration in which the SmartNIC presents a local NVMe device to the host using a SNAP (storage-defined network accelerated processing) driver, with the SmartNIC connected directly to an M.2 NVMe expansion card through a PCIe auxiliary interface.

FIG. 3 illustrates an edge mode configuration in which the SmartNIC processes host backup data and stores immutable snapshots or hidden partitions on remote centralized external storage, with the host accessing the SmartNIC-exposed storage through a SNAP driver.

FIG. 4 shows an arrangement of immutable snapshots managed by the SmartNIC, including online and historical snapshots with distinct retention periods, providing secure, point-in-time recovery capability.

FIG. 5 illustrates a hidden partitions algorithm in which online, latest, previous, and baseline partitions are controlled entirely by the SmartNIC isolated environment, with recovery performed from writable clones of protected partitions.

FIG. 6 depicts a timeline of partition rotation under the hidden partitions algorithm, showing periodic transitions in which new clones are promoted to the online state while older partitions are shifted or retired according to retention policy.

FIG. 7 illustrates a standalone configuration of the SmartNIC's OOB management port, in which a technician laptop is connected on demand to provide secure, isolated administrative access independent of the host system or production network.

FIG. 8 depicts a secured VLAN management configuration in which the SmartNIC's OOB management port communicates with a centralized web management server, enabling coordinated monitoring and control of multiple SmartNIC devices while preserving immutability enforcement.

FIG. 9 illustrates a centralized SmartNIC configuration augmented with machine-learning analytics that receive backup metadata, perform integrity and compliance analysis, and provide recommendations for recovery strategy while immutable snapshots remain protected under SmartNIC-enforced retention rules.

FIG. 10 illustrates a centralized configuration incorporating host memory forensics and cloud-based analysis, in which the SmartNIC acquires selected host RAM data through a telemetry framework such as DOCA Argus (or an equivalent in-memory monitoring framework) and exchanges backup metadata with an external cloud-based analytics system AWS Bedrock AgentCore or other AI-based analysis engines, while immutable snapshots stored on centralized storage remain protected from modification.

### DETAILED DESCRIPTION

The present invention introduces a SmartNIC-based (Smart Network Interface Card) resilient cyber recovery system tailored to address critical challenges in backup data protection, threat detection, and recovery in OT (Operational Technology) environments. This system leverages the advanced processing capabilities of SmartNICs to create an isolated runtime environment for performing secure storage operations, real-time cyber defense for backups, and advanced backup snapshot analytics. By isolating sensitive functions, it ensures high-security operations while maintaining system performance.

A core feature of the invention is its ability to operate in an isolated SmartNIC environment, enabling real-time monitoring, analysis, and defense mechanisms against cyber threats directly at the storage layer, whether it is local storage (embedded in the same server NVMe, SATA and similar local storage) or remote centralized storage (iSCSI, NVMe-oF and similar external storage protocols). This architecture ensures the protection of sensitive data from both external and internal threats by isolating critical operations from the host system. Sensitive processes, including cryptographic key handling, access control, and immutable snapshots generation, are executed entirely within the SmartNIC's isolated environment, rendering them inaccessible to external attackers targeting the host system.

The system's rapid recovery capabilities are a significant advancement in data resiliency. One embodiment demonstrates the ability to recover servers in just 30 seconds (the time of the restart and booting) from local storage by booting the server from an immutable snapshot SNAP (storage-defined network accelerated processing) drive. This functionality minimizes downtime and ensures the quick restoration of critical systems following a cyberattack or system failure. The use of immutable snapshots or a SmartNIC-based hidden partitions algorithm enhances data integrity and provides strong safeguards against unauthorized modification or deletion of backup data.

The invention operates in two primary configurations: Edge Mode and Centralized Mode. In Edge Mode, the system leverages local storage, where data is transmitted via PCIe to dedicated local storage on the M.2 NVMe PCIe expansion card, connected directly to the SmartNIC via dedicated SmartNIC auxiliary port (e.g. BlueField-3 DPU OCP 3.0 auxiliary connector). This configuration enables fully local backup operations, eliminating the consumption of network traffic, which is critical in sensitive OT/ICS networks. In both configurations, the storage subsystem is exclusively connected to the SmartNIC, such that all communications are mandatorily routed through the SmartNIC in an in-line (man-in-the-middle) manner, and no communication path exists that bypasses the SmartNIC, in order to enforce security constraints.

The system uses a SmartNIC-based immutable snapshot algorithm or employs a SmartNIC-based hidden partitions algorithm to protect backup data, ensuring that partitions remain inaccessible and unmapped during nominal operation, when the system is in a backup mode.

In Centralized Mode, the system is deployed so that the SmartNIC is disposed in-line between an OT/ICS network and at least one external storage system. The SmartNIC receives backup traffic originating from servers, controllers, and other devices in the OT/ICS network and forwards the backup traffic to the external storage while exposing to the OT/ICS network one or more logical backup volumes that are backed by the external storage system. The external storage infrastructure is capable of managing large-scale data, including NAS and cloud storage, and supports protocols such as iSCSI, NVMe-oF, SMB, AWS S3 (via a local AWS storage file gateway virtual machine), or other storage protocols. In this configuration, the SmartNIC functions as an in-line man-in-the-middle device that terminates and manages all communication between the OT/ICS network and the external storage, thereby enabling centralized creation and management of immutable backups and resource management for files, virtual machines (VMs), and microservices while offering robust protection for critical data.

In some embodiments, the invention also incorporates advanced analytics for anomaly detection and cyber threat mitigation. By utilizing the computing power of SmartNIC, the system can scan backups and detect anomalies that are specific to OT/ICS systems. For example, it can mount the storage within the SmartNIC isolated environment and identify suspicious additions or modifications to executable files, project files, or system configurations. Anomalies such as changes in entropy and significant fluctuations in differential backup size are detected as potential indicators of malicious activity, such as ransomware attacks or data exfiltration. The use of machine learning and AI algorithms enhances the system's ability to detect and analyze these threats effectively. This information is added as metadata to the immutable backup snapshot.

In some embodiments the SmartNIC might run multiple AV/EDR engines. In an isolated environment, the antivirus is harder to terminate, providing better security. The use of multiple engines also increases the likelihood of detecting attacks, offering more comprehensive protection. Furthermore, since it does not consume CPU or memory resources, it is especially crucial in OT/ICS environments, where maintaining system performance and stability is vital for critical operations. This information is added as metadata to the immutable backup snapshot.

The metadata attached to each of the backups can be used later for real-time analysis or for real-time detection when sent directly via the SmartNIC OOB management port to the SOC/SIEM.

In some embodiments, the SmartNIC is further configured to interface with a host telemetry framework, such as DOCA Argus or an equivalent monitoring framework, to obtain selected runtime data directly from the host's RAM while the backup is being generated. By analyzing in-memory process states, execution contexts, kernel structures, and other volatile data, the SmartNIC can detect attacks that reside only in memory or that are active on the host during the backup window, including fileless malware and in-memory lateral movement. The resulting analytics, such as anomaly scores, indicators of compromise, suspicious process trees, and memory region fingerprints, are then attached as security metadata to the immutable backup snapshot.

In some embodiments, the same analytics and security metadata may additionally be transmitted in real time, near real time, or at a later time to an external Security Operations Center (SOC) and/or Security Information and Event Management (SIEM) platform. This allows the data to be consumed as live telemetry for correlation with other security events, automated alerting, and incident response workflows, while simultaneously remaining embedded in the backup snapshot for later forensic analysis and integrity verification.

In some embodiments, the backup metadata can further be transmitted to external malware scanning and threat intelligence engines, such as Google Threat Intelligence or other external analysis engines, for additional inspection and correlation. The same metadata can also be sent to AI models or AI based analysis engines, deployed on premises or in the cloud, for example AWS Bedrock agents or AWS Bedrock AgentCore agents, to analyze anomalies, identify complex attack patterns, and refine risk assessments. The results of such external analysis may then be fed back into the system as updated security metadata, indicators of compromise, or policy recommendations, and stored together with the immutable backup snapshot or forwarded to SOC and SIEM platforms to enhance the overall security posture.

In some embodiments, the system further integrates snapshot analytics to provide forensic insights and to prevent reintroduction of malware during recovery. The SmartNIC scans immutable backups for indicators of compromise (IOCs), including known malicious file hashes, file paths, registry or configuration artifacts, and behavioral signatures stored as IOC definitions. IOC signatures may be obtained automatically from one or more malware engines or external threat-intelligence sources, or may be manually defined by an administrator for targeted threat hunting. The analytics engine additionally evaluates user and system activity across successive snapshots, identifies changes in files, executables, and configuration items between different backup points, and detects violations of software whitelists, such as unauthorized remote software installation. When suspicious artifacts are identified, the corresponding snapshot or data subset can be quarantined, isolated, or flagged as unsafe for production recovery, thereby reducing the risk that malware, dormant “time bombs”, or other latent compromises are reintroduced into an environment during restoration.

The invention employs a dedicated SmartNIC Out-of-Band (OOB) management port to manage and control the SmartNIC. For instance, such OOB port is available in the SmartNIC BlueField 3 DPU. This feature enables secure remote operation through SSH commands that are sent via the OOB management port. Users can configure parameters such as snapshot frequency, time synchronization between the host and the SmartNIC, backup time, retention periods, and backup modes, or monitor real-time status updates, such as last snapshot time and malware detected. To further enhance security, the OOB management port might support multi-factor authentication (MFA) and can operate in an air-gapped configuration to minimize exposure to potential attacks. In the case of air-gapped operation, the port will be connected to external devices only via secured VLAN or on demand.

In some embodiments, the SmartNIC Isolated Environment ensures that the SmartNIC's CPU, operating system, software, and code are inaccessible from the Host OS. Control is strictly managed through the OOB (Out of Band) management port, and no administrative, debug, or configuration interface is exposed to the Host OS. In this configuration, the SmartNIC operates as an independent, hardened security and data processing appliance that shares only the necessary data paths (e.g., network and storage) with the host, while keeping its control and management plane fully segregated.

In some embodiments, this Isolated Environment operates in a zero-trust mode, conceptually similar to the zero trust security capabilities of data processing units such as for instance the NVIDIA BlueField 3 DPU. In this mode, the host is treated as an untrusted or potentially compromised entity, and all administrative access to the SmartNIC is performed solely through the OOB management port. The SmartNIC enforces hardware and firmware level policies that prevent the host from modifying the SmartNIC operating system, security policies, or data plane configuration, while still allowing the SmartNIC to inspect, filter, and process network and storage traffic on behalf of the host. This zero-trust isolated mode strengthens the security boundary, mitigates the risk of host-based tampering with the security functions, and provides a hardened, out of band enforcement and monitoring point suitable for high security OT and ICS deployments.

In the edge mode, initial recovery is performed by booting from the SNAP—(storage-defined network accelerated processing) drive, which contains the immutable snapshot. The user can then operate from the immutable snapshot until the issue is resolved and the forensics process is completed. Once finished, the SNAP (storage-defined network accelerated processing) drive, containing the updated data, can be restored to the internal hard drive (either a new or the existing drive). This restoration process occurs in the background of the operation (when booted from the SNAP—storage-defined network accelerated processing), ensuring uninterrupted operation without downtime.

In centralized mode, the SmartNIC exposes the backup snapshots stored on the external storage as one or more logical backup volumes to devices in the OT/ICS network or to a recovery virtual machine, for example a NAS or SAN exposed over SMB, NFS, iSCSI, or similar protocols, while the SmartNIC generates immutable backups on this storage. The immutable backup snapshot may be stored as a virtual disk image (for example, VHD or VHDX) on the centralized storage system. During recovery, this virtual disk can be attached to a physical or virtual machine as a bootable disk and executed directly from the centralized storage, without first restoring the data to a local drive. Unlike the edge mode using the SNAP (storage-defined network accelerated processing) drive, where the SmartNIC presents the snapshot as a locally emulated storage device, in the centralized mode the storage remains remote and is presented directly to the operating system or hypervisor as a network-mounted bootable volume (for example, via iSCSI boot or a hypervisor-attached VHD). The user can operate from this immutable snapshot running on centralized storage until the issue is resolved and the forensics process is completed. Once finished, the updated system state can optionally be replicated or restored from the centralized storage back to a local internal hard drive, either in the background or during a planned maintenance window.

In some embodiments of the centralized mode, the SmartNIC implements a backup presentation function within the SmartNIC isolated environment. Immutable backup snapshots, or writable clones derived from such snapshots, that are stored on the external storage system are mapped by the SmartNIC to one or more logical backup volumes. These logical backup volumes are exposed to devices in the OT/ICS network as centralized network storage using standard storage or file-sharing protocols, such as SMB, NFS, iSCSI, or NVMe-over-Fabrics (NVMe-oF). From the perspective of the OT/ICS devices, the logical backup volumes appear as remote NAS or SAN resources accessed over the network, and not as locally attached storage devices emulated by the SmartNIC as in the edge mode.

In some embodiments, the logical backup volumes exposed in the centralized mode are backed by immutable backup snapshots enforced by the SmartNIC-based immutable snapshot algorithm described herein. When writable access is required for recovery or testing, the SmartNIC isolated environment creates a writable clone of a selected immutable backup snapshot and exposes only the clone as a logical backup volume, while the parent immutable backup snapshot remains unmodified and subject to its retention policy. All access to the snapshot-backed volumes continues to be mediated by the SmartNIC isolated environment, so that neither OT/ICS devices nor administrative users can delete or alter the immutable backup snapshots, even when the snapshots are accessed through SMB, NFS, iSCSI, or NVMe-oF in the centralized mode.

Two key algorithms provide robust data protection within the system: the SmartNIC-based immutable snapshot algorithm and the SmartNIC-based hidden partitions algorithm. The first ensures that snapshots cannot be deleted or modified until the retention period expires, even with administrative access. The second employs techniques to secure backup data within hidden partitions, rendering them inaccessible during standard operations. These partitions can only be accessed via specific commands through the OOB management port, further safeguarding the integrity of the backup data.

In some embodiments, the SmartNIC-based immutable snapshot algorithm enforces a strict retention period for each snapshot, during which cannot be altered or deleted via host-side or management commands during the retention period, including actions initiated by users or processes with full administrative privileges on the host. When a snapshot is created, the SmartNIC records its retention policy in protected metadata, which may include a minimum retention duration, an absolute expiration timestamp, and optional regulatory or policy tags. Until this retention period expires, any operation that would modify, overwrite, truncate, or delete blocks belonging to that snapshot is rejected by the SmartNIC, regardless of the command type or the privilege level of the requester on the host.

In some embodiments, these protections are implemented using the Storage Performance Development Kit (SPDK) snapshot and logical volume management capabilities. The SmartNIC may represent each protected snapshot as a logical volume or snapshot object managed by SPDK, while exposing to the host only a higher-level virtual block device that is backed by one or more SPDK bdevs and logical volumes. SPDK's snapshot functions, invoked through its JSON RPC interface, can be used to create point in time copies, track dependent volumes, and manage the mapping between live data and snapshot data. The SmartNIC's control plane, running within the isolated environment, is the only component allowed to issue these RPC commands. Host initiated I/O is limited to standard read and write paths and is never allowed to directly invoke SPDK snapshot or deletion operations.

In some embodiments, the retention enforcement logic is integrated with SPDK's snapshot metadata so that snapshots are tagged internally with retention attributes and state flags. The SmartNIC control software periodically evaluates these attributes and, only when the retention period has expired and any additional policy conditions are satisfied, issues controlled SPDK JSON RPC commands to mark the corresponding snapshot blocks as reclaimable.

In some embodiments, management of snapshots and their retention policies is performed exclusively through the OOB management port, using a secure API or command line interface provided by the SmartNIC. Administrators interact with the system by requesting operations such as “create immutable snapshot,” “list snapshots,” or “schedule release after retention,” but the underlying SPDK RPC commands and low-level operations remain hidden and inaccessible from the host OS. Even if the same physical media is shared between live data volumes and immutable snapshot volumes, the host and its administrators cannot directly see or manipulate the SPDK objects that correspond to immutable snapshots, nor can they issue JSON RPC calls to modify them.

In some embodiments, for recovery from immutable snapshots, the SmartNIC provides an option to create a writable clone from an existing immutable snapshot while preserving the original snapshot in its immutable state. Using SPDK's snapshot and clone capabilities, the immutable snapshot is treated as a read-only parent, and a new logical volume is created as a writable child whose modifications are redirected to new storage extents. The writable clone can then be exposed to the host or to a recovery VM as an active volume for testing, remediation, or staged rollback, while the original immutable snapshot remains unchanged and protected by its retention policy. After validation, the writable clone may be promoted to become the new production volume or discarded, without ever modifying or weakening the guarantees provided by the parent immutable snapshot.

In some embodiments, the SmartNIC-based hidden partitions algorithm is implemented using the Storage Performance Development Kit (SPDK) logical volume and block device (bdev) framework. The SmartNIC terminates NVMe, NVMe-oF, iSCSI, or similar storage protocols in user space via SPDK, and constructs one or more logical volumes that are designated as “hidden partitions.” These hidden partitions are created on top of the same physical media as the visible host volumes, but are never exposed as discoverable namespaces, LUNs, or block devices to the host. Instead, SPDK bdev and lvol modules are used to split the underlying device into: (i) a “public” logical volume that is presented to the host as a standard block device, and (ii) one or more “hidden” logical volumes that are only accessible to the SmartNIC control plane via SPDK's JSON RPC interface.

In some embodiments, the SmartNIC configures SPDK so that the host only sees a single virtual bdev corresponding to the public volume. All I/O from the host is directed to this bdev, which internally maps to specific LBA ranges or logical extents that explicitly exclude the address space reserved for the hidden partitions. The hidden partitions occupy separate lvols or namespaces that are not referenced by the public bdev, and therefore cannot be reached by any read, write, trim, or unmap request issued by the host. From the host's perspective, the hidden partitions simply do not exist: they are not reported in NVMe Identify Namespace responses, SCSI INQUIRY data, or any other standard enumeration mechanism.

In some embodiments, all operations involving the hidden partitions are carried out exclusively through SPDK's JSON RPC commands, which are bound to the SmartNIC's control plane running in the isolated environment. The RPC endpoint is never exposed to the host network stack or the host OS; it is only reachable via the OOB management port or an equivalent secure management channel. Administrative actions such as creating a hidden lvol, resizing it, attaching it as a read-only view for forensic analysis, or mounting it for internal SmartNIC processing are implemented as SPDK RPC calls that can only be initiated by authenticated management clients over the OOB path. As a result, even a host administrator with root privileges cannot issue SPDK RPCs or manipulate hidden partitions directly.

In some embodiments, during a controlled recovery mode and with sufficient administrative privileges, the hidden partition can be temporarily brought online through the OOB management channel. Access to this operation may require strong authentication, such as multi-factor authentication, and is only permitted to authenticated management clients connected via the OOB interface. When authorized, the SmartNIC control plane issues SPDK JSON RPC commands to momentarily map the hidden logical volume as a read-only or read-write block device, either to a dedicated recovery or forensic virtual machine or, in tightly controlled scenarios, to a host-side environment. Once the recovery or investigation is completed, the management plane can instruct SPDK to unmap and offline the hidden partition again, restoring it to its non-enumerated, non-discoverable state from the perspective of the standard host OS.

The invention's dual operational modes also extend to its deployment flexibility. For instance, in one embodiment, the system includes portable backup & recovery software pre-configured on a dedicated SNAP partition (storage-defined network accelerated processing) drive which is not related to the backup storage, eliminating the need for customers to install agents in their environments. This approach is particularly beneficial for OT/ICS systems, where Industrial Automation vendors restrict the installation of software agents.

This invention offers a comprehensive and robust solution for enhancing data security, threat detection, and recovery in OT/ICS environments. Through its innovative use of SmartNIC technology, it addresses critical challenges in protecting sensitive data, minimizing recovery times, and ensuring the integrity of backups. The incorporation of advanced analytics, secure algorithms, and flexible deployment options further solidifies its utility in a wide range of applications.

### DETAILED DESCRIPTION OF FIGURES

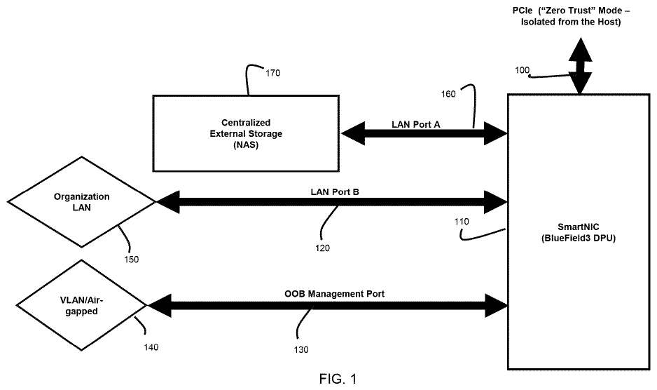

FIG. 1 illustrates a centralized backup configuration of the SmartNIC-based cyber recovery system. A SmartNIC (110) is coupled on one side to an organization LAN (150) and on the other side to centralized external storage (170), for example a NAS system that stores backup images and virtual disk snapshots for devices on the LAN. Servers, programmable logic controllers (PLCs), human-machine interface (HMI) stations, and engineering workstations on the organization LAN (150) send backup and recovery traffic through the SmartNIC (110) rather than directly to the external storage (170). Within a SmartNIC isolated environment that is logically and administratively separated from the host operating system, the SmartNIC (110) terminates the storage traffic and executes SmartNIC-based immutable snapshot or hidden partitions algorithms entirely on the SmartNIC (110). These algorithms generate immutable backup snapshots and/or maintain hidden backup locations on the centralized external storage (170), such that backup data cannot be modified or deleted by LAN-attached devices, by host administrators, or via the OOB management port during a configured retention period. A dedicated Out-of-Band (OOB) management port of the SmartNIC (110) is coupled to a separate management network (140), which may be implemented as a physically air-gapped link that is connected on demand to a technician laptop or as a VLAN-segmented management network connected to a centralized management server. The OOB management port constitutes the sole management interface to the SmartNIC isolated environment and is used to configure backup policies, retention parameters, and recovery operations independently of the organization LAN (150). In this centralized arrangement, the SmartNIC (110) functions as an in-line enforcement and analytics point between the organization LAN (150) and the centralized external storage (170), ensuring that backups of servers, PLCs, HMI stations, and engineering workstations are created, stored, and analyzed under SmartNIC-enforced immutability.

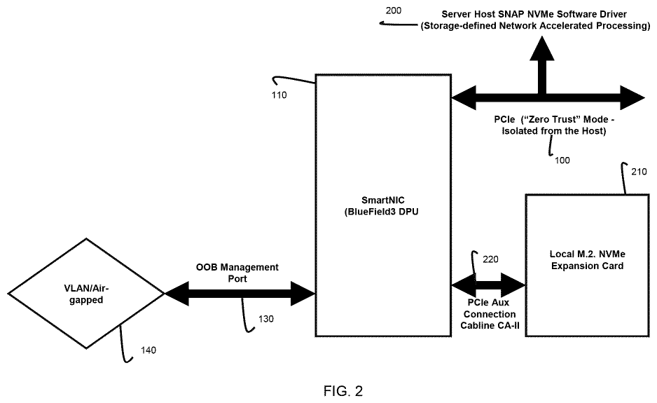

FIG. 2 illustrates an edge-mode configuration of the SmartNIC-based cyber recovery system in which the SmartNIC (110) is used to perform backup and recovery operations for the host system itself. In this configuration, the SmartNIC (110) is coupled to the host system through a PCIe interface operating in a zero-trust mode (100) that prevents the host operating system from accessing any administrative, debug, or configuration functions of the SmartNIC isolated environment. A backup and recovery software component executing on the host system writes backup data directly to an immutable snapshot or to an online partition of a hidden partitions algorithm that is presented to the host as a local NVMe device. This presented NVMe device is backed by a physical M.2 NVMe expansion card (210) that is connected exclusively to the SmartNIC (110) through a PCIe auxiliary connection (220), such as a Cabline-CA-II connector or equivalent high-speed board-to-board interface. All storage operations written by the host to the presented NVMe device are intercepted and terminated within the SmartNIC isolated environment. Within this isolated environment, the SmartNIC (110) executes SmartNIC-based immutable snapshot or hidden partitions algorithms entirely on the SmartNIC hardware. These algorithms create immutable snapshots and/or maintain hidden partitions on the local NVMe storage (210), ensuring that backup data generated by the host cannot be modified or deleted by the host operating system, by host administrators, or through any path other than the controlled SmartNIC management interface during a configured retention period. A SNAP (storage-defined network accelerated processing) NVMe software driver (200) running on the host exposes the presented immutable snapshot or online partition as a SNAP (storage-defined network accelerated processing) drive. During a recovery operation, a user, via the OOB management interface (130), can select a desired immutable snapshot or online partition, and the SmartNIC (110) presents the corresponding SNAP (storage-defined network accelerated processing) drive as a bootable device so that the host system can be booted directly from the selected recovery point. The SmartNIC (110) further includes an Out-of-Band (OOB) management port (130) coupled to a separate management network (140), which may be VLAN-segmented or physically air-gapped and connected on demand to a technician laptop. The OOB management port constitutes the sole management interface to the SmartNIC isolated environment, allowing a technician to configure retention policies, select recovery snapshots or partitions, and manage hidden partitions without exposing any administrative interface to the host. In this edge-mode arrangement, the SmartNIC (110) functions as a secure in-line storage controller for the host system, enforcing immutability and isolation guarantees on the host's own backup data and providing a SmartNIC-controlled recovery mechanism independent of the host operating system.

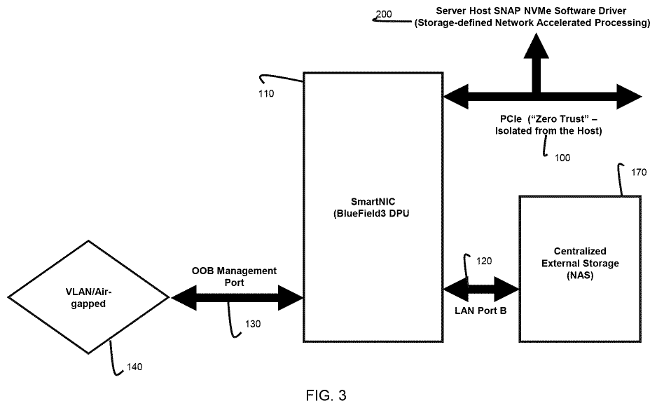

FIG. 3 illustrates an edge-mode configuration of the SmartNIC-based cyber recovery system in which the SmartNIC (110) performs backup and recovery operations for the host system while storing backup data on a remote storage system such as a NAS. The SmartNIC (110) is coupled to the host system through a PCIe interface operating in a zero-trust mode (100) that prevents the host operating system from accessing administrative, debug, or configuration functions of the SmartNIC isolated environment. A SNAP (storage-defined network accelerated processing) NVMe software driver (200) executing on the host presents to the host a logical block device that is backed by SmartNIC-managed storage resources. The SmartNIC (110) is also connected to centralized external storage (170) through a network interface designated as LAN Port B (120). The centralized external storage (170) may be implemented as a NAS that provides one or more logical volumes for different servers, for example iSCSI LUNs, SMB shares, NVMe-over-Fabrics namespaces, or other network-attached block or file storage resources. Backup and recovery software running on the host writes backup data to the logical device exposed by the SNAP (storage-defined network accelerated processing) driver (200). The SmartNIC (110) terminates and processes these write operations within the SmartNIC isolated environment and forwards the corresponding storage updates to the centralized external storage (170). Inside the SmartNIC isolated environment, the SmartNIC (110) executes SmartNIC-based immutable snapshot or hidden partitions algorithms entirely on the SmartNIC hardware. These algorithms create immutable backup snapshots and/or maintain hidden partitions on the remote storage (170), ensuring that backup data stored on the NAS, including on iSCSI LUNs or other logical volumes, cannot be modified or deleted by the host operating system, by host administrators, or through any interface other than the SmartNIC-controlled management interface during a configured retention period. During a recovery operation, a user, via the OOB management interface, selects a desired immutable snapshot or an online partition associated with a particular server. The SmartNIC (110) then maps the selected immutable snapshot or online partition as the logical device presented by the SNAP (storage-defined network accelerated processing) driver (200) so that the host can treat the selected recovery point as its active system disk. The host system can be booted directly from this logical device, for example by configuring the host firmware or hypervisor to boot from the SNAP (storage-defined network accelerated processing) device, thereby restoring the host to the selected recovery state while the underlying immutable snapshot remains protected. The SmartNIC (110) further includes an Out-of-Band (OOB) management port (130) coupled to a separate management network (140), which may be VLAN-segmented or physically air-gapped and connected on demand to a technician laptop or to a centralized management server. The OOB management port (130) is the sole administrative interface to the SmartNIC isolated environment and is used to configure retention parameters, manage hidden partitions, and select immutable snapshots for backup and recovery operations. In this centralized-mode configuration, the SmartNIC (110) functions as an in-line storage controller between the host and the centralized external storage (170), ensuring that backups and restorations performed to logical volumes on a shared NAS remain immutable and are executed under SmartNIC-enforced security constraints.

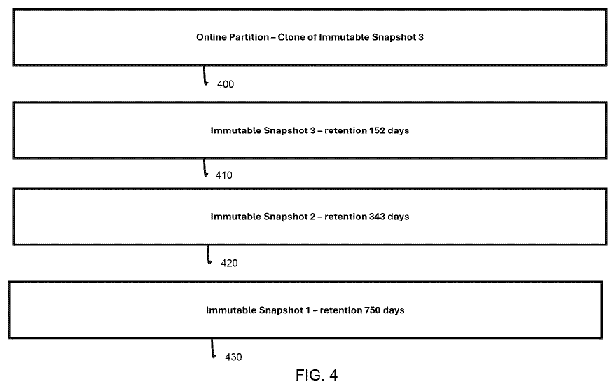

FIG. 4 illustrates the operation of the SmartNIC-based immutable snapshot algorithm executed within the SmartNIC isolated environment. In this embodiment, an online partition (400) is exposed to the host system as the active writable volume. The online partition (400) represents a writable clone derived from a selected immutable snapshot, such as Immutable Snapshot 3 (410), and contains the most recent system state as updated by backup software executing on the host. Beneath the online partition, the SmartNIC maintains a sequence of immutable snapshots (410), (420), (430), each created at different points in time and each associated with a predefined retention period. For example, Immutable Snapshot 3 (410) may be assigned a retention period of 152 days, Immutable Snapshot 2 (420) a retention period of 343 days, and Immutable Snapshot 1 (430) a retention period of 750 days. These immutable snapshots store point-in-time copies of the system state and are maintained in a strictly read-only condition by the SmartNIC. The SmartNIC isolated environment enforces immutability for each snapshot such that no process on the host, no administrator, and no management command received through the SmartNIC OOB management interface can modify or delete the snapshot during its enforced retention period. New snapshot creation, expiration, and deletion policies are performed entirely inside the SmartNIC isolated environment and are not accessible to the host operating system. The immutable snapshots (410), (420), (430) provide verifiable historical recovery points. When a recovery operation is initiated, the SmartNIC may generate a fresh writable clone of any immutable snapshot and present it as the new online partition (400), enabling the system to be booted from a clean and verified recovery point without altering the underlying immutable snapshot. The layered arrangement shown in FIG. 4 demonstrates how the SmartNIC maintains multiple immutable snapshots across varying retention horizons while exposing a single writable online partition (400). This architecture enables reliable long-term data preservation and secure point-in-time recovery under SmartNIC-enforced immutability controls.

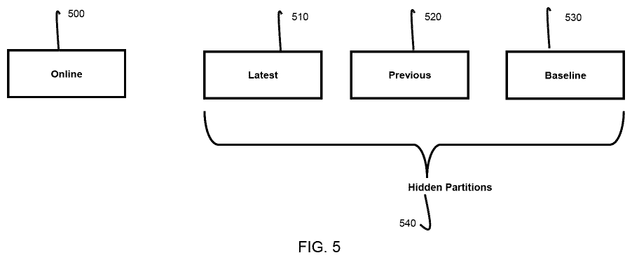

FIG. 5 illustrates an embodiment of a SmartNIC-based hidden partitions algorithm. The SmartNIC maintains multiple logical partitions, including an Online partition (500), a Latest partition (510), a Previous partition (520), and a Baseline partition (530). During normal backup operation, only the Online partition (500) is exposed to the host, while the Latest (510), Previous (520), and Baseline (530) partitions remain hidden and are not mapped as accessible block devices, thereby preventing host-side processes or administrators from modifying their contents. In a recovery mode, an administrator uses the SmartNIC's Out-of-Band management interface to select one of the hidden partitions (510), (520), (530). The SmartNIC first creates a writable clone of the selected hidden partition and designates that clone as the Online partition (500), which is then presented to the host as the active storage device. Restoration is thus performed from the clone rather than directly from the hidden partition, allowing targeted recovery while keeping the original Latest, Previous, and Baseline images securely preserved within the SmartNIC isolated environment.

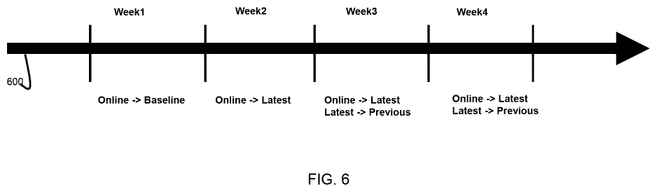

FIG. 6 illustrates an example timeline for partition rotation under the SmartNIC-based hidden partitions algorithm. At each update interval, such as a weekly backup cycle, the SmartNIC creates a new writable clone from a selected hidden partition and designates this clone as the Online partition (600). The previously Online clone is re-labeled as the Latest partition (610), and an older Latest partition transitions to the Previous partition (620). When an older Previous partition reaches the end of its retention window, its clone may be offlined, discarded, or retained for long-term archival in accordance with the configured retention policy. The Baseline partition (630) remains unchanged during normal rotation and serves as a clean reference state unless explicitly updated by an administrator through the SmartNIC Out-of-Band management interface. By performing these transitions through controlled cloning and relabeling rather than by modifying the original hidden partitions, the SmartNIC ensures that backups are systematically rotated and securely maintained while preserving intact recovery points within the SmartNIC isolated runtime environment.

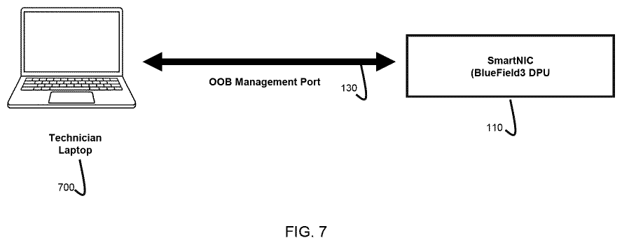

FIG. 7 illustrates a standalone configuration of the SmartNIC Out-of-Band (OOB) management interface. In this arrangement, a technician laptop (700) is connected on demand directly to the SmartNIC (110) through the OOB management port (130). The SmartNIC operates autonomously and does not rely on the host system or the production network for administrative access. The dedicated OOB connection provides a secure and isolated channel for issuing management commands, performing device configuration, monitoring system status, and initiating recovery operations. This configuration is suitable for environments that require air-gapped or restricted-access management, ensuring that administrative control of the SmartNIC remains isolated from the host operating system and from normal network traffic.

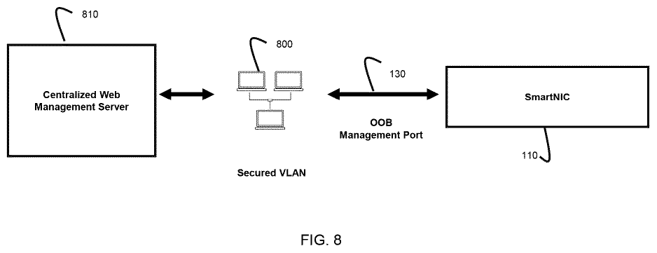

FIG. 8 illustrates a secured VLAN management configuration in which the SmartNIC (110) is administered through its Out-of-Band (OOB) management port (130) over a segmented and secured VLAN (800). In this arrangement, the OOB management port (130) communicates with a centralized web management server (810) that provides unified monitoring and control of multiple SmartNIC devices deployed across a distributed environment. The secured VLAN (800) delivers an isolated and protected management channel that is separated from production network traffic. Through the centralized web management server (810), administrators can perform configuration changes, monitor real-time operational status, manage retention and recovery policies, and orchestrate recovery operations for numerous SmartNIC-equipped systems. Even when accessed over this secured VLAN and using administrator credentials, the SmartNIC-enforced retention logic prevents immutable snapshots from being modified or deleted before expiration of their respective retention periods, thereby ensuring that administrative traffic cannot weaken the immutability guarantees of the backup data.

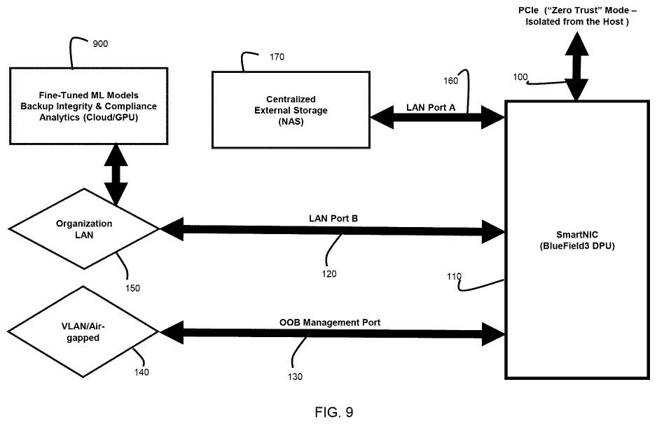

FIG. 9 illustrates a centralized configuration similar to that shown in FIG. 1, with the addition of a machine-learning analysis component. A SmartNIC (110) is positioned in-line between the organization LAN (150) and centralized external storage (170). Backup traffic originating from devices on the organization LAN (150) is routed through LAN Port B (120) to the SmartNIC (110), which terminates and processes the storage traffic within a SmartNIC-isolated environment operating in a zero-trust PCIe configuration (100). The SmartNIC (110) forwards the processed backup data to the centralized external storage (170) through LAN Port A (160) while executing SmartNIC-based immutable snapshot or hidden-partitions algorithms entirely on the SmartNIC hardware. Administrative access to the SmartNIC isolated environment is provided solely through the Out-of-Band (OOB) management port (130) coupled to a VLAN-segmented or air-gapped management network (140). Fine-tuned machine-learning models (900), which may operate on cloud-based or GPU-accelerated infrastructure, receive backup data and associated metadata from the SmartNIC over the organization LAN (150). These models perform backup-integrity, anomaly-detection, and compliance analytics, including identifying indicators of compromise, entropy deviations, or configuration irregularities. The results of the analysis may be appended as metadata to the corresponding immutable snapshot, and such metadata may be transmitted to external systems or returned to the SmartNIC (110) for use in assisting an administrator with selecting an appropriate recovery point or determining a restoration strategy.

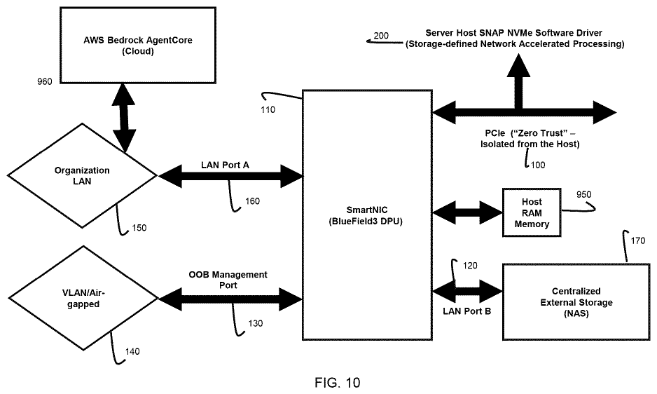

FIG. 10 illustrates a centralized-mode configuration similar to that shown in FIG. 3, with the addition of host-memory forensics and cloud-based analytics. A SmartNIC (110) is coupled to the host system through a PCIe interface operating in a zero-trust mode (100), preventing the host operating system from accessing administrative, debug, or configuration functions of the SmartNIC isolated environment. A SNAP (storage-defined network accelerated processing) NVMe software driver (200) executing on the host presents SmartNIC-managed storage resources to the host as a logical NVMe device. The SmartNIC (110) receives backup traffic through LAN Port B (120) and writes backup data to centralized external storage (170) while executing SmartNIC-based immutable snapshot or hidden-partitions algorithms entirely within the SmartNIC isolated environment. Administrative access to the SmartNIC is provided solely through the Out-of-Band (OOB) management port (130) connected to a VLAN-segmented or air-gapped management network (140). In this embodiment, the SmartNIC (110) also interfaces with a host telemetry framework, such as DOCA Argus or an equivalent in-memory inspection system, to obtain selected runtime data from the host RAM (950) during the backup window. The SmartNIC may analyze in-memory process states, execution contexts, kernel structures, and other volatile memory regions to detect indicators of compromise, fileless malware, or anomalous activity that resides only in RAM and is not visible through file-level inspection. Analytics derived from this memory forensics process are attached as metadata to the corresponding immutable backup snapshot stored on the centralized storage (170). Additionally, the organization LAN (150) may provide connectivity to an external AI-based analysis platform, such as an AWS Bedrock AgentCore system (960). This external system may perform integrity analysis, anomaly detection, compliance checks, or correlation with external threat-intelligence sources using backup data or metadata supplied by the SmartNIC. Metadata generated by such external analysis may be returned to the SmartNIC (110) or stored alongside the immutable snapshot to assist an administrator in selecting a clean recovery point or determining an appropriate restoration strategy. Even when host-memory forensics through DOCA Argus and external cloud-based analytics through AgentCore are performed, immutable snapshots stored on the centralized external storage (170) remain protected by SmartNIC-enforced retention policies and cannot be modified or deleted before expiration of their respective retention periods. FIG. 10 therefore demonstrates the integration of SmartNIC-controlled backup operations with host-level memory forensics and cloud-based analytics while maintaining strict immutability and isolation guarantees.

What is claimed is:

1. A cyber recovery system, comprising:
a. a SmartNIC installed in a host system and arranged in-line between between at least one backed-up computing device (which may be the host system itself or a separate device) and at least one storage subsystem and at least one storage subsystem, the SmartNIC comprising a SmartNIC isolated environment that is administratively and logically isolated from an operating system of the host system and from an operating system of the backed-up computing device and being configured such that storage input/output operations issued by the backed-up computing device to the storage subsystem are routed through the SmartNIC;
b. wherein the host system and the backed-up computing device communicate with the SmartNIC only via data paths for network and storage traffic and have no management, debug, or configuration interface to the SmartNIC isolated environment;
c. a snapshot engine executing in the SmartNIC isolated environment and configured to create immutable backup snapshots on the storage subsystem, the snapshot engine being further configured to enforce, for each immutable backup snapshot, a retention period during which modification or deletion of data of the immutable backup snapshot is blocked irrespective of host or SmartNIC management credentials associated with, or an interface over which, a request to modify or delete the data is received;
d. a management interface comprising a dedicated Out-of-Band (OOB) management port coupled to the SmartNIC and constituting a sole management interface exposed for administrative access to the SmartNIC isolated environment, the OOB management port being configured to receive management commands for creating the immutable backup snapshots and for configuring retention parameters for the immutable backup snapshots, wherein the snapshot engine is configured to ignore management commands, including management commands received via the OOB management port, that would modify or delete data of an immutable backup snapshot before expiration of the retention period; and
e. a recovery mechanism implemented by the SmartNIC and configured, in response to a recovery command received via the management interface, to create a recovery volume as a clone of at least one of the immutable backup snapshots and to expose the recovery volume as a bootable storage volume to the backed-up computing device such that the backed-up computing device can be booted from the recovery volume while a corresponding immutable backup snapshot remains unmodified.

2. The system of claim 1, wherein the SmartNIC is further configured to:
a. implement at least one of: (i) a SmartNIC-based immutable snapshot algorithm; and (ii) a SmartNIC-based hidden partitions algorithm, to create backups that are protected from modification or deletion during a retention period and scanned for indicators of compromise;
b. maintain on the storage subsystem, at least one hidden partition that is created and managed by the SmartNIC and that remains unmapped and inaccessible to the backed-up computing device during normal operation.

3. The system of claim 1, wherein the recovery mechanism is further configured to:
a. recover the backed-up computing device within a short time interval from local storage by booting the backed-up computing device from a recovery volume created as a clone of an immutable backup snapshot and presented as a SNAP (storage-defined network accelerated processing) drive; and
b. perform restoration of internal storage of the backed-up computing device in a background process while the backed-up computing device operates from the recovery volume, thereby maintaining system availability.

4. The system of claim 1, further comprising:
a. an analytics engine implemented in the SmartNIC isolated environment and configured to mount backup data within an operating system of the SmartNIC to detect anomalies specific to OT/ICS systems, including malicious modifications of programmable logic controller (PLC) project files, entropy changes, and significant fluctuations in differential backup size; and
b. machine learning and artificial intelligence techniques configured to assist in detecting malware-free backups and generating forensic insights based on analysis of the mounted backup data.

5. A method for secure data backup, comprising:
a. generating immutable backup snapshots on a SmartNIC using a SmartNIC-based immutable snapshot algorithm executed in a SmartNIC isolated environment;
b. isolating backup operations within one or more hidden partitions created and managed by the SmartNIC on a storage subsystem, wherein the hidden partitions remain unmapped and inaccessible from a network and from an operating system of a backed-up computing device during normal operations; and
c. employing encryption and secure storage techniques to protect cryptographic keys and sensitive data associated with the backups from unauthorized access.

6. The method of claim 5, further comprising:
a. operating the SmartNIC in an Edge Mode, including transmitting data via a PCIe interface to dedicated local storage on an NVMe expansion card and creating local backups on the NVMe expansion card without consuming network bandwidth, thereby ensuring operational continuity in sensitive OT/ICS environments; and
b. coupling remote storage to a machine over a storage network using a storage protocol selected from the group consisting of iSCSI and NVMe-over-Fabrics (NVMe-oF), and exposing, by a SNAP (storage-defined network accelerated processing) component executing on the SmartNIC, the remote storage to the machine as local storage.

7. The method of claim 5, further comprising snapshot recovery, comprising:
a. booting a system from a recovery volume created as a clone of an immutable backup snapshot on a SmartNIC, wherein the recovery volume replaces an internal hard drive of a backed-up computing device during a recovery process while the immutable backup snapshot remains unmodified; and
b. managing recovery operations through a dedicated Out-of-Band (OOB) management port of the SmartNIC using secure management commands that are processed in a SmartNIC isolated environment.

8. The method of claim 7, wherein the recovery process comprises:
a. detecting and isolating malware in backup snapshots using at least one of multi-engine malware scanning and anomaly detection executed in the SmartNIC isolated environment; and
b. identifying clean backups and quarantining infected data based on results of the malware scanning or anomaly detection, thereby ensuring integrity of backup data prior to recovery.

9. A system for centralized storage management in an operational technology (OT) or industrial control systems (ICS) environment, comprising:
a. a SmartNIC disposed in-line between an OT/ICS network and at least one external storage system, the SmartNIC comprising a SmartNIC isolated environment that is administratively and logically isolated from an operating system of any host system in which the SmartNIC is installed and from devices in the OT/ICS network and being configured such that backup traffic between the OT/ICS network and the external storage system is routed through the SmartNIC;
b. wherein the host system and the devices in the OT/ICS network communicate with the SmartNIC only via data paths for network and storage traffic and have no management, debug, or configuration interface to the SmartNIC isolated environment;
c. a snapshot engine executing in the SmartNIC isolated environment and configured to create immutable backup snapshots on the external storage system, the snapshot engine being further configured to enforce, for each immutable backup snapshot, a retention period during which modification or deletion of data of the immutable backup snapshot is blocked irrespective of credentials associated with, or an interface over which, a request to modify or delete the data is received;
d. a management interface comprising a dedicated Out-of-Band (OOB) management port coupled to the SmartNIC and constituting a sole management interface exposed for administrative access to the SmartNIC isolated environment independently of the OT/ICS network and of the host system, the OOB management port being configured to receive management commands for creating the immutable backup snapshots and for configuring retention parameters for the immutable backup snapshots, wherein the snapshot engine is configured to ignore management commands, including management commands received via the OOB management port, that would modify or delete data of an immutable backup snapshot before expiration of the retention period;
e. a monitoring subsystem executing in the SmartNIC isolated environment and configured to intercept substantially all backup-related storage traffic between the OT/ICS network and the external storage system and to selectively allow, block, or modify storage operations in accordance with one or more security or data-protection policies; and
f. a backup presentation component executing in the SmartNIC isolated environment and configured to expose, to devices in the OT/ICS network, one or more logical backup volumes backed by the immutable backup snapshots stored on the external storage system via at least one storage protocol selected from the group consisting of SMB, NFS, iSCSI, and NVMe-over-Fabrics (NVMe-oF), the logical backup volumes being presented as centralized network storage rather than as local storage devices attached to the devices in the OT/ICS network.

10. The system of claim 9, wherein the monitoring subsystem is further configured to:
a. perform snapshot analytics on backup snapshots stored on the external storage system in the SmartNIC isolated environment, including detecting changes in files between different backup snapshots and performing entropy analysis to identify indications of malicious encryption; and
b. interface with a plurality of malware-detection engines executing on or accessible to the SmartNIC to scan backup data and classify backup snapshots as clean or infected prior to using the backup snapshots in a recovery operation.

11. The method of claim 5, further comprising a initiating a backup analytics and threat detection system for an operational technology or industrial control system (OT/ICS) environment, comprising: a SmartNIC configured to be disposed in-line between at least one backed-up computing device and at least one storage subsystem, the SmartNIC comprising a SmartNIC isolated environment; a snapshot interface configured to access, within the SmartNIC isolated environment, backup snapshots stored on the storage subsystem; an analytics engine executing in the SmartNIC isolated environment and configured to perform threat detection on data represented by the backup snapshots and to generate, for each backup snapshot, security metadata indicative of a threat-detection result; and a policy engine configured to use the security metadata to generate recovery recommendations, including identifying backup snapshots that are preferred or disfavored for recovery based on the threat-detection result.
